(19) United States
(12) Patent Application Publication
(10) Pub. No.: US 2025/0119513 A1
(43) Pub. Date: Apr. 10, 2025

(54) EVENT VIDEO RECORDING SYSTEM FOR AUTONOMOUS VEHICLES AND OPERATING METHOD FOR THE SAME

(71) Applicants: HYUNDAI MOTOR COMPANY, Seoul (KR); Kia Corporation, Seoul (KR)

(72) Inventor: Dong Hyuk Jeong, Hwaseong-si (KR)

(73) Assignees: HYUNDAI MOTOR COMPANY, Seoul (KR); Kia Corporation, Seoul (KR)

(21) Appl. No.: 18/904,895

(22) Filed: Oct. 2, 2024

(30) Foreign Application Priority Data
Oct. 4, 2023 (KR) 10-2023-0131583

(51) Int. Cl. H04N 7/18; B60W 60/00; G01S 13/86; G06V 20/40; G06V 20/58; H04N 5/77; H04N 23/90

(52) U.S. Cl. CPC H04N 7/188; B60W 60/00; G06V 20/44; G06V 20/58; H04N 5/77; B60W 2420/403; B60W 2420/408; G01S 13/862; G01S 13/865; G01S 13/867; H04N 23/90

(57) ABSTRACT

An event video recording system and method of a vehicle, includes at least two detection sensor modules configured to set detection areas in at least two directions with respect to an external area and detect whether an object is approaching each of the detection areas; at least two cameras mounted respectively corresponding to the detection sensor modules, each configured to be turned on to operate based on a detection result of a corresponding detection sensor module among the detection sensor modules to obtain a video of a corresponding detection area among the detection areas; and a predicted event video recording storage configured to record a video obtained by a camera in operation.

### CROSS-REFERENCE TO RELATED APPLICATION

The present application claims priority to Korean Patent Application No. 10-2023-0131583, filed on Oct. 4, 2023, the entire contents of which is incorporated herein for all purposes by this reference.

### BACKGROUND OF THE PRESENT DISCLOSURE

### Field of the Present Disclosure

The present disclosure relates to an event video recording system of a vehicle and an operating method thereof.

### Description of Related art

In general, due to the development of the automobile industry, vehicles have been widely commercialized to the point where this is referred to as a one-car-per-household era, and accordingly, there are frequent occurrences of various vehicle-related accidents, for example, minor collisions with other vehicles while driving, vehicle thefts during parking, and damage to vehicles such as scratches by others.

In response to these vehicle-related accidents, it has become increasingly common for vehicles to be mounted with video capturing and recording devices known as black boxes (e.g., dash cameras). That is, a user may use a camera-obtained video or image stored in a video capturing and recording device (or simply a video recording device herein) to identify the circumstances of a vehicle accident, decide on right and wrong in a minor collision, capture an image of the looks of a thief attempting to steal a vehicle, show damage done to a vehicle, and the like.

Furthermore, due to growing consumer demands and technological advancements, a video recording device is mounted with 4-channel (front/back/left/right) cameras, high-definition (HD) cameras including full HD cameras, and a large flash memory for storing numerous video data. Furthermore, various convenience functions are added, such as, for example, a display function that allows users to view camera-obtained videos or images while recording, and a function for transferring a camera-obtained image or video to a smartphone.

On the other hand, a typical video recording device may have an always-on recording mode and an event recording mode.

The always-on recording mode may refer to a mode in which images captured by a camera are all stored in a flash memory and the like until the end of the power supply from the start of the power supply to the video recording device. For example, in the always-on recording mode, when a power source of the video recording device is connected to a vehicle battery, videos or images recorded by the video recording device may be stored for 24 hours regardless of whether the vehicle is driving or parked/stopped.

The event recording mode may refer to a mode in which, when a camera is driven, images are continuously captured, instead of being stored all the time, and when an impact value greater than a threshold value is detected while a G-sensor is detecting an occurrence of an impact, a corresponding image is stored in a flash memory and the like.

Although the always-on recording mode of the typical technology described above may have its advantages in that it obtains all the images related to vehicle-related accidents (hereinafter collectively referred to as “vehicle accidents”) such as minor collisions, vehicle theft, and vehicle damage, the always-on recording mode may have some issues such as, for example, a discharging issue of a vehicle battery due to excessive use, a shortage of storage capacity by storing a large amount of video data, and a loss of important video data due to the overwriting of the latest video data.

The always-on recording mode of the typical technology may include an issue of a shortened life of a flash memory with the limited number of data writes when storing a large amount of video data. Thus, to secure a vehicle accident video, a user may need to purchase a new flash memory every six months to a year and a half to replace the old one, which may incur expense and inconvenience.

In addition, although the event recording mode of the typical technology described above may have its advantages in that it effectively uses a flash memory compared to the always-on recording mode by storing a corresponding image when an impact occurs, the event recording mode may also have some issues such as, for example, it may not be able to obtain images before a vehicle accident occurs because it stores only images after a G-sensor senses an impact.

For example, in a case of vehicle vandalism where someone scratches a vehicle with a nail and the like, the typical technology may obtain only a video after the scratch, but may not obtain evidential data from which the overall circumstances of the vehicle vandalism are identified, including, for example, a video showing the surroundings before, during, and after the scratch, a video showing a person approaching the vehicle to make the scratch, a video showing how the person makes the scratch, and the like.

Therefore, in recent years, various technologies have been in development to secure videos from before an occurrence of a vehicle accident to a time of the vehicle accident and after the occurrence of the vehicle accident, and solve the issues described above such as, for example, discharging a vehicle battery, a shortage of storage capacity, a loss of important video data, and a shortened life of a non-volatile storage medium due to the limited number of data writes.

However, the vehicle video recording methods described above may have technical limitations in that they are not suitable for autonomous vehicles expected to be more widely commercialized in the near future.

This is because autonomous vehicles need to be operated very efficiently in terms of power consumption and storage space for recorded images or videos by basically having at least 4 channels, or 8 channels to the maximum, of cameras that acquire images, and by having various detection means for detecting the surroundings for autonomous driving and avoidance driving. However, numerous technologies developed up to the present time have failed to satisfy the present requirement.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an event video recording system and method of a vehicle, which may include various detection sensors configured to detect the surroundings and a plurality of cameras configured to observe areas detected respectively by the detection sensors, and may be configured to determine an event occurrence probability based on data obtained from the detection sensors, and selectively record and store a video (or image) obtained by a camera observing a detection area with a high event occurrence probability to maintain optimal storage capacity. Here, the detection sensors may be turned on or off selectively according to a driving environment, and thus unnecessary power consumption by the detection sensors may be prevented.

To solve the preceding technical problems, according to an exemplary embodiment of the present disclosure, there is mounted an event video recording system of a vehicle, including: at least two detection sensor modules each configured to detect an object approaching within a detection area in a preset direction, at least two cameras mounted respectively corresponding to the at least two detection sensor modules, each configured to be turned on to operate based on a detection result of a corresponding detection sensor module among the at least two detection sensor modules to obtain a video of a corresponding detection area, and a predicted event video recording storage configured to record the video.

According to an exemplary embodiment of the present disclosure, each of the at least two detection sensor modules may include at least one LiDAR, at least one radio detection and ranging (RADAR), at least one ultrasonic sensor, or a combination thereof.

According to an exemplary embodiment of the present disclosure, the event video recording system may further include an event occurrence probability calculator configured to determine an event occurrence probability based on data of a result of the detecting.

According to an exemplary embodiment of the present disclosure, the event occurrence probability calculator is configured to determine the event occurrence probability based on the video.

According to an exemplary embodiment of the present disclosure, the predicted event video recording storage is configured to record a video including an event occurrence probability higher than a threshold.

To solve the preceding technical problems, according to an exemplary embodiment of the present disclosure, there is mounted an event video recording system of a vehicle, including at least two cameras configured to view respectively in at least two viewing directions different from one another, at least one LiDAR configured to detect an object in one of the at least two viewing directions, at least one radio detection and ranging (RADAR) mounted at a front portion or a rear portion of the vehicle, at least one ultrasonic sensor mounted on a side portion of the vehicle, a weather determination unit configured to determine a weather condition to determine to operate the LiDAR, a vehicle speed determination unit configured to determine to operate the ultrasonic sensor based on a driving speed of the vehicle, a camera video analysis processing unit configured to analyze a video obtained by the at least two cameras, an event occurrence probability calculator configured to determine an event occurrence probability based on a result of analyzing a video by the camera video analysis processing unit or data detected by the at least one LiDAR, the at least one ultrasonic sensor, or the at least one radar, and a predicted event video recording storage configured to record a video obtained by a camera viewing a direction with an event occurrence probability higher than a threshold among the at least two cameras.

According to an exemplary embodiment of the present disclosure, the weather determination unit is configured to check an operating state of wipers or fog lights of the vehicle, and deactivate the LiDAR based on a result of the checking.

According to an exemplary embodiment of the present disclosure, the vehicle speed determination unit may be configured to, in response to the driving speed of the vehicle being less than or equal to a preset threshold value, activate the ultrasonic sensor.

According to an exemplary embodiment of the present disclosure, the vehicle speed determination unit may be configured to, in response to the driving speed of the vehicle being less than or equal to the preset threshold value, activate the ultrasonic sensor, and deactivate the LiDAR through the weather determination unit.

According to an exemplary embodiment of the present disclosure, the radar may operate in an always-on operation mode, and a video obtained by a camera viewing a detection area detected by the radar among the at least two cameras may be stored in the predicted event video recording storage in an always-on recording mode.

According to an exemplary embodiment of the present disclosure, the event video recording system may further include an autonomous driving controller configured to operate independently of the event occurrence probability calculator, determine an event occurrence probability based on data detected by the LiDAR, the ultrasonic sensor, or the radar and select a path of a lowest event occurrence probability to drive the vehicle, and control the predicted event video recording storage to store a video obtained by a camera viewing a path of a highest event occurrence probability among the at least two cameras.

To solve the preceding technical problems, according to an exemplary embodiment of the present disclosure, there is mounted an event video recording method of a vehicle including at least two cameras viewing at least two viewing directions different from one another, at least one LiDAR detecting an object in one of the at least two viewing directions, at least one radar mounted at a front portion or a rear portion of the vehicle, and at least one ultrasonic sensor mounted on a side portion of the vehicle, the event video recording method including a camera video analysis step of analyzing a video obtained by the at least two cameras a first determination step of determining a first event occurrence probability based on the video analyzed in the camera video analysis step a second determination step of determining a second event occurrence probability based on data detected by the LiDAR, the ultrasonic sensor, or the radar and a camera video recording and storing step of recording and storing a video obtained by a camera, among the at least two cameras, viewing a direction of an event occurrence probability higher than a threshold among the first event occurrence probability and the second event occurrence probability.

According to an exemplary embodiment of the present disclosure, the event video recording method may further include determining to operate the LiDAR in response to a result of checking a weather condition.

According to an exemplary embodiment of the present disclosure, the event video recording method may further include: determining that a driving speed of the vehicle is less than or equal to a preset threshold value; and in response to the driving speed being determined to be less than or equal to the threshold value, activating the ultrasonic sensor.

According to an exemplary embodiment of the present disclosure, the weather condition is determined based on an operating state of wipers or fog lights of the vehicle, wherein, the event video recording method further includes deactivating the at least one LiDAR according to the weather condition.

According to an exemplary embodiment of the present disclosure, the event video recording method may further include in response to the driving speed being less than or equal to the preset threshold value, activating the ultrasonic sensor and deactivating the LiDAR.

According to an exemplary embodiment of the present disclosure, the radar may be configured to operate in an always-on operation mode, and the event video recording method may further include storing, in an always-on recording mode, a video obtained by a camera viewing an area being detected by the radar among the at least two cameras.

According to an exemplary embodiment of the present disclosure, the event video recording method may further include driving the vehicle by selecting a path of a lowest second event occurrence probability, and recording and storing a video obtained by a camera viewing a path of a highest second event occurrence probability among the at least two cameras.

According to various exemplary embodiments of the present disclosure described herein, an event video recording system of an autonomous vehicle and its operating method may perform camera recording only for a direction from which a collision is predicted (e.g., an object is detected) using autonomous driving-related sensors, without storing unnecessary images by a driving video recording function, to effectively reduce storage capacity, and may operate the autonomous driving-related sensors selectively according to a driving environment to reduce power consumption.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating an event video recording system of a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. The exemplary embodiments are not construed as limited to the present disclosure and should be understood to include all changes, equivalents, and replacements within the idea and the technical scope of the present disclosure.

The terms “module,” “unit,” and/or “-er/or” for referring to elements are assigned and used interchangeably in consideration of the convenience of description, and thus the terms per se do not necessarily have different meanings or functions. The terms “module,” “unit,” and/or “-er/or” do not necessarily require physical separation.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein include the same meaning as commonly understood by one of ordinary skill in the art to which the present disclosure pertains. Terms, such as those defined in commonly used dictionaries, are to be interpreted as having a meaning which is consistent with their meaning in the context of the relevant art and the present disclosure, and are not to be interpreted in an idealized or overly formal sense unless expressly so defined herein.

Furthermore, the term “unit” or “control unit” is merely a widely used term for naming a controller that is configured to control a specific vehicle function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, decision, and the like that are necessary for controlling a function assigned thereto.

Meanwhile, a processor may include a semiconductor integrated circuit and/or electronic devices that perform at least one or more of comparison, determination, computation, operations, and decision to achieve programmed functions. The processor may be, for example, any one or a combination of a computer, a microprocessor, a central processing unit (CPU), an application-specific integrated circuit (ASIC), and an electronic circuit (e.g., circuitry and logic circuits).

Furthermore, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, an event video recording system of an autonomous vehicle and an operating method of the event video recording system according to various exemplary embodiments of the present disclosure will be described in detail with reference to the accompanying drawings.

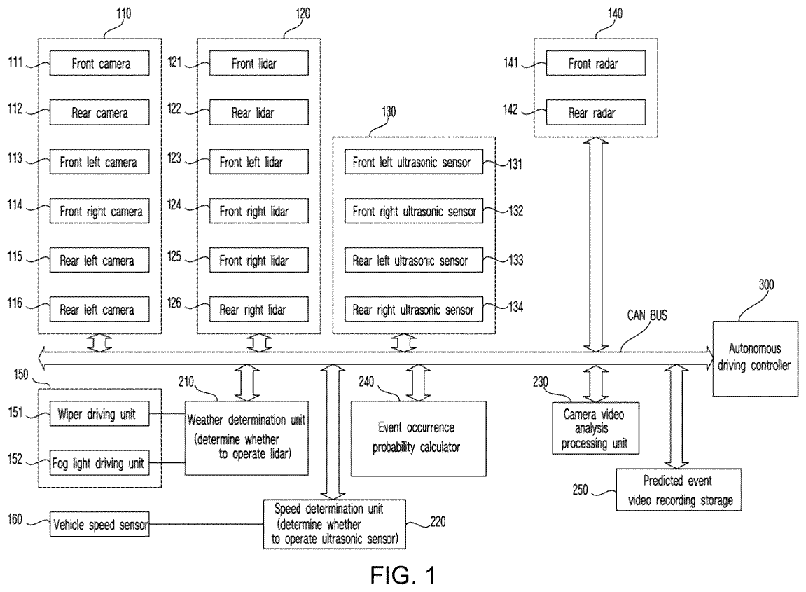

FIG. 1 is a block diagram illustrating an event video recording system of a vehicle according to an exemplary embodiment of the present disclosure. The event video recording system may include: a camera module 110 including a plurality of cameras embedded in an autonomous vehicle; a LiDAR module 120 including a plurality of LiDARs (e.g., a light detection and ranging (LiDAR) sensor or a laser imaging, detection, and ranging (LiDAR) sensor); a radar module 140 including a plurality of radars mounted at the front or rear of the vehicle; an ultrasonic sensor module 130 including a plurality of ultrasonic sensors mounted on the sides of the vehicle; a weather determination unit 210 configured to determine whether to operate the LiDAR module 120 by checking a weather condition; a vehicle speed determination unit 220 configured to determine whether to operate the ultrasonic sensor module 130 based on a driving speed of the vehicle; a camera video analysis processing unit 230 configured to analyze a video obtained by the camera module 110; an event occurrence probability calculator 240 configured to determine an event occurrence probability based on the video analyzed by the camera video analysis processing unit 230 or determine an event occurrence probability based on data detected by the radar module 140, the ultrasonic sensor module 130, or the LiDAR module 120. In an exemplary embodiment, the event occurrence probability calculator 240 may determine the probability based on the distance of an object from the vehicle and the speed thereof obtained through the camera video analysis processing unit 230 or the data detected by the radar module 140, the ultrasonic sensor module 130, or the LiDAR module 120. For example, when an object approaches from a specific direction and it is determined that a collision by the object is likely to occur based on the distance and the speed of the object, the event occurrence probability calculator 240 may determine that the event occurrence probability related to the direction is high. Further, in an exemplary embodiment, when two objects respectively approaches from two directions and it is determined that collisions by the objects are likely to occur based on the distances and the speeds of the objects, the event occurrence probability calculator 240 may determine that the event occurrence probability related to the object which is determined to be collided prior to the other object is higher. The event video recording system may further include a predicted event video recording storage 250 configured to record and store a video obtained by a camera included in the camera module 110 that views in a direction including a predetermined event occurrence probability based on the event occurrence probability determined by the event occurrence probability calculator 240.

The radar module 140, the ultrasonic sensor module 130, or the LiDAR module 120 may be collectively referred to as a detection sensor module.

The weather determination unit 210 may check an operating state of a safe driving assistance unit 150 including a wiper driving unit 151 and a fog light driving unit 152 of the vehicle, and when it is determined that the weather condition is not clear (i.e., cloudy), deactivate the LiDAR module 120.

This is because a LiDAR operates under a similar operation principle to that of a radar. However, the radar utilizes radio waves, whereas the LiDAR utilizes infrared (IR) light, visible light (VL), ultraviolet (UV) light, and a laser beam. The LiDAR, or a LiDAR system, emits a laser beam at a target and detects a signal reflected from the target using a laser sensor. Furthermore, it utilizes a ray ranging from a near-infrared ray (e.g., near-infrared radiation (NIR)) with an extremely short wavelength of 850 to 1550 nanometers (nm) to a short wave infrared ray (e.g., short wave infrared radiation (SWIR)), and may thus include a desirable distance accuracy with a few centimeters and precisely control a spatial resolution of about 0.1 degrees) (°). The LiDAR system may therefore easily obtain three-dimensional (3D) images of the surrounding environment.

However, the LiDAR may not be able to operate normally in rainy or snowy weather because it recognizes rain or snow as an object. In dense fog, the LiDAR may also recognize fine water droplets forming the fog as objects.

Thus, based on such characteristics of the LiDAR, when the weather condition is determined to be cloudy, the weather determination unit 210 may deactivate the LiDAR module 120 to prevent an unnecessary potential malfunction and prevent power consumption.

Furthermore, the speed determination unit 220 may recognize a current driving speed of the vehicle from a speed sensor (e.g., a speed sensor 160), and activate the ultrasonic sensor module 130 when the driving speed is less than or equal to a preset threshold value (e.g., 30 km/h).

In the instant case, the ultrasonic sensor module 130 and the LiDAR module 120 may operate inversely to each other. At a low speed of the vehicle, the ultrasonic sensor module 130 may be more efficient than the LiDAR module 120, and thus during low-speed driving of the vehicle even in a clear weather condition, the ultrasonic sensor module 130 may operate and the LiDAR module 120 may maintain its OFF state, preventing unnecessary power consumption.

Furthermore, the camera module 110 may include a front camera 111, a rear camera 112, a front left camera 113, a front right camera 114, a rear left camera 115, and a rear right camera 116 to ensure that no blind spots exist when viewing the outside of the vehicle.

Furthermore, the LiDAR module 120 may include a front LiDAR 121, a rear LiDAR 122, a front left LiDAR 123, a front right LiDAR 124, a rear left LiDAR 125, and a rear right LiDAR 126 to detect or navigate the surroundings in directions viewed by the cameras 111 to 116 included in the camera module 110.

Furthermore, the radar module 140 may include a front radar 141 configured to detect the front side of the vehicle and a rear radar 142 configured to detect the rear side of the vehicle. Although not shown, the rear radar 142 may include a rear left radar configured to detect the rear left side of the vehicle and a rear right radar configured to detect the rear right side of the vehicle.

Furthermore, the ultrasonic sensor module 130 may include a front left ultrasonic sensor 131 and a front right ultrasonic sensor 132, a rear left ultrasonic sensor 133, and a rear right ultrasonic sensor 134, and may operate when the vehicle is traveling at a low speed under the control of the speed determination unit 230.

Furthermore, an autonomous driving controller (e.g., an autonomous driving controller 300) may be configured to determine an event occurrence probability, independently of the operation of the event occurrence probability calculator 240, based on data detected by the LiDAR module 130, the ultrasonic sensor module 130, or the radar module 140, and select a path with the lowest event occurrence probability to drive the vehicle. In the instant case, the autonomous driving controller 300 may be configured for controlling the predicted event video recording storage 250 to store a video obtained by the camera module 110 viewing a path with the highest event occurrence probability.

The present disclosure provides the event video recording system and method for an autonomous vehicle, which are configured and operated as described above, and may effectively reduce a storage capacity by not storing unnecessary videos by a driving video recording function but recording only a direction (object) in which a potential collision is expected (or detected) through cameras using autonomous driving-related sensors, and may reduce power consumption by selectively activating the autonomous driving-related sensors in accordance with a driving environment.

Furthermore, the autonomous driving controller 300 and the event occurrence probability calculator 240 may be configured to determine the event occurrence probability respectively, and thus even when a malfunction occurs in either thereof, the driving video recording function may continue to operate.

In an exemplary embodiment of the present disclosure, each of the weather determination unit 210, the vehicle speed determination unit 220, the camera video analysis processing unit 230, and the event occurrence probability calculator 240 and may be implemented by a processor in a form of hardware or software, or in a combination of hardware and software. Alternatively, the weather determination unit 210, the vehicle speed determination unit 220, the camera video analysis processing unit 230, and the event occurrence probability calculator 240 may be implemented as a single processor in a form of hardware or software, or in a combination of hardware and software.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be mounted as one chip, or mounted as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An event video recording system of a vehicle, the event video recording system comprising:
at least two detection sensor modules each configured to detect an object approaching within a detection area of the vehicle in a preset direction;
at least two cameras mounted respectively corresponding to the at least two detection sensor modules, each configured to be turned on to operate based on a detection result of a corresponding detection sensor module among the at least two detection sensor modules to obtain a video of a corresponding detection area; and
a predicted event video recording storage configured to record the video.

2. The event video recording system of claim 1, wherein each of the at least two detection sensor modules includes at least one LiDAR, at least one radio detection and ranging (RADAR), at least one ultrasonic sensor, or a combination thereof.

3. The event video recording system of claim 1, further including an event occurrence probability calculator configured to determine an event occurrence probability based on data of the detection result.

4. The event video recording system of claim 3, wherein the event occurrence probability calculator is further configured to determine the event occurrence probability based on the video.

5. The event video recording system of claim 3, wherein the predicted event video recording storage is further configured to record a video including an event occurrence probability higher than a threshold.

6. An event video recording system of a vehicle, the event video recording system comprising:
at least two cameras configured to view respectively in at least two viewing directions different from one another;
at least one LiDAR configured to detect an object in one of the at least two viewing directions;
at least one radio detection and ranging (RADAR) mounted at a front portion or a rear portion of the vehicle;
at least one ultrasonic sensor mounted on a side portion of the vehicle;
a weather determination unit configured to determine a weather condition to determine to operate the at least one LiDAR;
a vehicle speed determination unit configured to determine to operate the at least one ultrasonic sensor based on a driving speed of the vehicle;
a camera video analysis processing unit configured to analyze a video obtained by the at least two cameras;
an event occurrence probability calculator configured to determine an event occurrence probability based on a result of analyzing the video by the camera video analysis processing unit or data detected by the at least one LiDAR, the at least one ultrasonic sensor, or the at least one RADAR; and
a predicted event video recording storage configured to record a video obtained by a camera viewing a direction with an event occurrence probability higher than a threshold among the at least two cameras.

7. The event video recording system of claim 6, wherein the weather determination unit is further configured to check an operating state of wipers or fog lights of the vehicle, and deactivate the at least one LiDAR based on a result of the checking.

8. The event video recording system of claim 6, wherein the vehicle speed determination unit is further configured to activate the at least one ultrasonic sensor, in response to the driving speed of the vehicle being less than or equal to a preset threshold value.

9. The event video recording system of claim 6, wherein the vehicle speed determination unit is further configured to activate the at least one ultrasonic sensor, and deactivate the at least one LiDAR through the weather determination unit, in response to the driving speed of the vehicle being less than or equal to a preset threshold value.

10. The event video recording system of claim 6,
wherein the at least one RADAR operates in an always-on operation mode, and
wherein a video obtained by a camera viewing a detection area detected by the at least one RADAR among the at least two cameras is stored in the predicted event video recording storage in the always-on recording mode.

11. The event video recording system of claim 6, further including an autonomous driving controller configured to:
operate independently of the event occurrence probability calculator, determine an event occurrence probability based on data detected by the at least one LiDAR, the at least one ultrasonic sensor, or the at least one RADAR and select a path of a lowest event occurrence probability to drive the vehicle; and
control the predicted event video recording storage to store a video obtained by a camera viewing a path of a highest event occurrence probability among the at least two cameras.

12. An event video recording method of a vehicle including at least two cameras viewing at least two viewing directions different from one another, at least one LiDAR detecting an object in one of the at least two viewing directions, at least one radio detection and ranging (RADAR) mounted at a front portion or a rear portion of the vehicle, and at least one ultrasonic sensor mounted on a side portion of the vehicle, the event video recording method comprising:
a camera video analysis step of analyzing a video obtained by the at least two cameras;
a first determination step of determining a first event occurrence probability based on the video analyzed in the camera video analysis step;
a second determination step of determining a second event occurrence probability based on data detected by the at least one LiDAR, the at least one ultrasonic sensor, or the at least one RADAR; and
a camera video recording and storing step of recording and storing a video obtained by a camera, among the at least two cameras, viewing a direction of an event occurrence probability higher than a threshold among the first event occurrence probability and the second event occurrence probability.

13. The event video recording method of claim 12, further including:
determining to operate the at least one LiDAR in response to a result of checking a weather condition.

14. The event video recording method of claim 12, further including:
determining that a driving speed of the vehicle is less than or equal to a preset threshold value; and
in response to the driving speed being determined to be less than or equal to the threshold value, activating the at least one ultrasonic sensor.

15. The event video recording method of claim 13,
wherein the weather condition is determined based on an operating state of wipers or fog lights of the vehicle, and
wherein, the event video recording method further includes deactivating the at least one LiDAR according to the weather condition.

16. The event video recording method of claim 14, further including:
in response to the driving speed being less than or equal to the preset threshold value, activating the at least one ultrasonic sensor and deactivating the at least one LiDAR.

17. The event video recording method of claim 12,
wherein the at least one RADAR is configured to operate in an always-on operation mode, and
wherein the event video recording method further includes storing, in the always-on recording mode, a video obtained by a camera viewing an area being detected by the at least one RADAR among the at least two cameras.

18. The event video recording method of claim 12, further including:
driving the vehicle by selecting a path of a lowest second event occurrence probability, and recording and storing a video obtained by a camera viewing a path of a highest second event occurrence probability among the at least two cameras.
